(19) United States
(12) Patent Application Publication
(10) Pub. No.: US 2018/0009271 A1
(43) Pub. Date: Jan. 11, 2018

(54) SYSTEM FOR EVALUATING THE SPEED OF A TIRE

(71) Applicants: COMPAGNIE GENERALE DES ETABLISSEMENTS MICHELIN, CLERMONT-FERRAND (FR); MICHELIN RECHERCHE ET TECHNIQUE S.A., Granges-Paccot (CH)

(72) Inventors: THOMAS LEDOUX, Clermont-Ferrand (FR); DENIS MARTIN, Clermont-Ferrand (FR); GUILLAUME HEREDIA, Clermont-Ferrand (FR); ALEXANDRE PERNOT, Clermont-Ferrand (FR)

(21) Appl. No.: 15/535,276

(22) PCT Filed: Dec. 16, 2015
(86) PCT No.: PCT/EP2015/080073

§ 371 Date: Jun. 12, 2017

(30) Foreign Application Priority Data
Dec. 17, 2014 (FR) 1462591

(51) Int. Cl. B60C 11/24; G01M 17/02; B60C 25/00; G01P 3/66

(52) U.S. Cl. CPC B60C 11/246; G01M 17/02; B60C 25/007; G01P 3/66

(57) ABSTRACT

A speed evaluation system is provided for assessing a speed of a vehicle. The speed evaluation system includes a wear measurement system, which assesses a state of a tire of the vehicle. The wear measurement system includes a casing placed on a ground surface. The speed evaluation system further includes a timing device that determines at least two instants of passage of the vehicle over two distinct or non-distinct points of passage of the casing of the wear measurement system, and a processor that calculates, as a function of the instants of passage and of dimensional data of the casing and/or dimensional data of the vehicle, a speed of passage of the vehicle over the casing. A method of implementing the speed evaluation system also is provided.

### FIELD OF THE INVENTION

The present invention relates to a system for assessing the speed of a vehicle. More particularly, the present invention relates to an external system, that is to say not embedded in the vehicle.

To measure the speed of a motor vehicle, systems installed on board vehicles are conventionally known for determining the speed of a vehicle as a function of the number of wheel revolutions of said vehicle.

Also known are systems which are based on the satellite positioning (GPS) for estimating the speed of a vehicle. Such systems allow a display of the speed in a vehicle to inform the driver. Also known are systems used by the police, called “radar”. These systems are generally based on the doppler effect to perform the speed measurement.

The present invention aims to provide a system, that can notably be used by vehicle fleet managers, and which can be included in a more global system for diagnosing the state of a vehicle and of its tires. Now, none of the known systems allows, in the current state, any cross checking with other information relating to the vehicle whose speed is measured.

Thus, the aim of the present invention is to provide a system for assessing the speed of a vehicle which is ergonomic both for a vehicle driver and for a vehicle fleet manager.

The present invention therefore proposes such an autonomous system for assessing the state of the speed of a tire.

### BRIEF DESCRIPTION OF THE INVENTION

Thus, the invention proposes a system for assessing the speed of a vehicle, the system comprising:
a system for assessing the state of a tire comprising a casing placed on the ground,
means for determining at least two instants of passage of the vehicle over two distinct or non-distinct points of passage of the casing of the measurement system, and
means for calculating, as a function of the instants of passage and of dimensional data of the casing and/or of the vehicle, a speed of passage of the vehicle over the casing.

Preferentially, the system for assessing the state of a tire is a wear measurement system comprising a casing placed on the ground in which there are advantageously installed:
a tire wear detection device,
at least one device for detecting the presence of a tire on the casing, and
electronic means for activating the wear detection device upon the detection of the presence of a tire.

The wear detection device preferentially implements at least one sensor placed inside the casing, in proximity to a face of the casing intended to be in contact with the surface of the tire, and capable of measuring the distance separating said sensor from the metal reinforcements forming the tire.

The sensor comprises, for example, a static or alternating magnetic field source and an adjacent sensitive element, the source being a coil or a permanent magnet and the sensitive element being a sensor whose output signal can, for example, be a function of the level of the local magnetic induction field. In this case, the sensitive element is positioned such that the intensity of the magnetic field varies when the distance which separates said sensor from the metal reinforcements forming the tire decreases. The sensitive element is preferably chosen from the group of Hall-effect or magneto-resistive sensors.

Alternatively, the sensor is an eddy current sensor.

In another preferential embodiment, the assessment system comprises at least one device for measuring a characteristic of a tire, for example the pressure of a tire.

The first device for detecting the presence of a tire comprises at least one element included in the group comprising: a sensor or ferroelectret type (PP, CYTOP, etc.), an organic piezoelectric sensor, a piezoelectric cable and/or fibre, a piezoelectric transducer, a piezoelectric bimetallic strip or a sensor produced in the form of inorganic piezoelectric compound applied to a support. The piezoelectric compound can, for example, be a paint with added barium titanate, an oxide known for its ferroelectric properties. Any other element having ferroelectric properties, like, for example and non-exhaustively, TGS, PZT, BST, KNbO3, LiNbO3, LiTaO3, could be used as additive to a conventional paint to form a piezoelectric compound that can be used in the context of the present device.

In a particular embodiment, the speed assessment system comprises means for storing dimensional data of the casing. These dimensional data comprise, in particular but not exclusively, the distances between different elements incorporated in the casing, for example piezoelectric sensors, piezoelectric cables, or electrodes covered with piezoelectric paint. “Distance” should be understood here to mean the distance between the respective projections of the elements onto a same plane, parallel to the plane on which the vehicle is moving.

In a particular embodiment, the system for assessing the speed of a vehicle comprises vehicle identification means. These means are, for example, an RFID reader, incorporated in or on the casing, or in proximity. Such a reader can make it possible to read the identifier of an RFID chip incorporated in one or more tires of the vehicle or affixed to the chassis of said vehicle. This RFID reader is preferentially linked by telecommunication means to a remote database making it possible to establish a link between an RFID identifier and a tire and/or a vehicle.

Furthermore, in another preferential embodiment, the system comprises means for exchanging information with a remote database, comprising dimensional information on the identified vehicle. The dimensional information comprises, for example, the dimension of the tires, the wheelbase, the front track or the rear track of the vehicle.

The invention relates also to a method for assessing the speed of a vehicle passing over a casing of a system for assessing the state of a tire of the vehicle, the method comprising the following steps:
a step of determination of a first instant of passage of the vehicle over the casing,
a step of determination of a second instant of passage of the vehicle over the casing,
a step of calculation, as a function of the two instants of passage and of dimensional data of the casing and/or of the vehicle, of a speed of passage of the vehicle over the first casing.

In a particular embodiment, the method is such that the steps of determination of a first and second instants of passage of the vehicle over the casing consist in the detection of the passage of a same wheel at two distinct points or non-distinct points of passage of the casing. Thus, for example, it is possible to detect the passage of a wheel over a device for activating the measurement device and the passage of the same wheel over the measurement device. It is also possible to detect the passage of a wheel over two elements of a tire presence detection device, the elements being included in the group comprising: piezoelectric sensors, piezoelectric cables, or even electrodes covered with a piezoelectric paint, or with any other elements sensitive to the local deformation of the structure of the casing forming the system for assessing the state of a tire.

In another particular embodiment, the method is such that the steps of determination of a first and second instants of passage of the vehicle over the casing consist in the detection of the passage of two distinct axles of the vehicle at a single point of the casing. This single point can be, for example, the measurement device, or else the device for activating the measurement device.

In another particular embodiment, the method is such that the steps of determination of a first and second instants of passage of the vehicle over the casing consist respectively in the detection of an impact on the casing, and in the detection of a passage of a wheel over a device for activating the measurement device or over the measurement device. In this case, the detection of an impact can be ensured, for example, by any sensor sensitive to impacts, such as accelerometers, vibration or tilt sensors, omnidirectional sensors (for example of SQ-SEN-200 type from the company SignalQuest), piezoelectric buzzers, strain gauges, or sensors based on piezoelectric compounds glued at a single point of the structure of the casing.

In this latter case, the first instant of passage corresponding to the detection of an impact on the casing, it is possible to detect said first instant with greater accuracy by correcting it of the time of propagation of the shockwave in the material forming the casing of the measurement system. To do this, the correction is a function of the rigidity of the material.

### DETAILED DESCRIPTION OF THE INVENTION

Other advantages and embodiments of the invention will become apparent with the detailed description of the figures, given in a non limiting manner, and which represent different embodiments of an assessment system according to the invention. Using these figures, the different implementations of a method according to the invention will also become apparent.

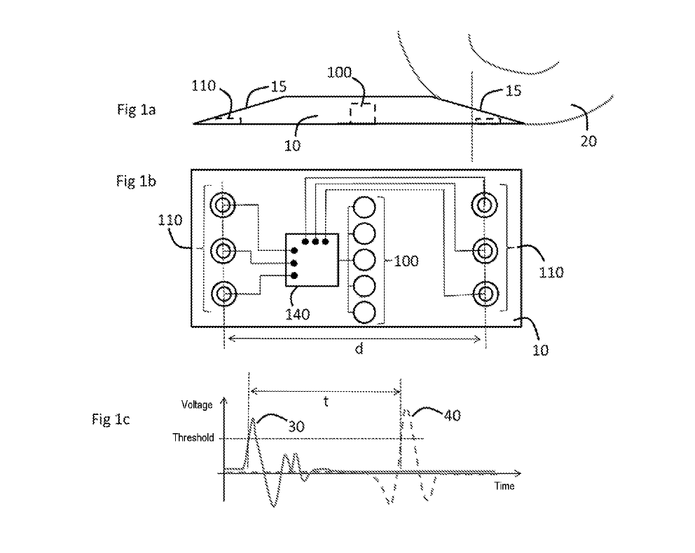

In the example of FIGS. 1a and 1b, the speed assessment system implements a wear measurement system consisting of:
A casing 10 consisting of two access ramps 15 and a horizontal wear measurement zone situated between the two access ramps 15.
Two tire presence detection devices each consisting of three piezoelectric sensors 110, positioned along a transverse line in the direction of rolling of a vehicle arriving on the casing. In this example, the piezoelectric sensors are buzzers glued onto the structure of the casing 10.
A line of wear measurement sensors 100 positioned along a transverse line in the direction of rolling of the vehicle arriving on the casing 10. These wear measurement sensors can, without preference, be variable reluctance sensors, or eddy current sensors. Alternatively, it is also possible to replace this row of electromagnetic wear sensors by an optical wear measurement system applying the principle of laser triangulation.
Processing electronics 140 to which the wear measurement sensors 100 and the tire presence detection sensors 110 are connected. In this example, the processing electronics 140 also contain an RFID reader making it possible to read RFID chips incorporated in the tires or glued onto the vehicle for which the speed, and the wear of the tires, are measured.

Upon the passage of a tire 20 over the casing 10 of the wear measurement system, the presence of the tire is first of all detected by a first row of tire presence detection sensors 110, then, when the tire leaves the casing 10 of the wear measurement system, its presence is detected by a second row of tire presence detection piezoelectric sensors 110.

FIG. 1c shows, by continuous line, an example of signal 30 recorded at the output of a piezoelectric sensor 110 situated in the first row of tire presence detection sensors, and by discontinuous line, an example of signal 40 recorded at the output of a piezoelectric sensor 110 situated in the second row of tire presence detection sensors.

In the example of FIGS. 1a, 1b and 1c, the processing electronics 140 comprise a threshold detection circuit and a time base which make it possible to assess the time t that elapses between the passage of a tire 20 over the first row of tire detection sensors 110 and the passage of said tire 20 over the second row of tire detection sensors 110.

The instant of passage over a row of sensors 110 is detected by the output signal 30 or 40 crossing a predetermined threshold.

In another exemplary embodiment, the threshold detection electronics can be replaced by rising and/or falling edge detection electronics, in order to assess the time t between the passage of a tire 20 over the first row of tire detection sensors 110 and the passage of said tire 20 over the second row of tire detection sensors 110.

This assessment of the time t between the tire entering and leaving the casing 10 of the wear measurement device makes it possible to calculate the average speed of passage of the tire over the device. This is done simply by using the following formula:

Average speed=d/t

In this example, the distance d is the distance separating the two transverse rows of tire presence detection sensors 110. This distance can be either prestored in a memory of the processing electronics, or stored in a remote database comprising dimensional data of the casing.

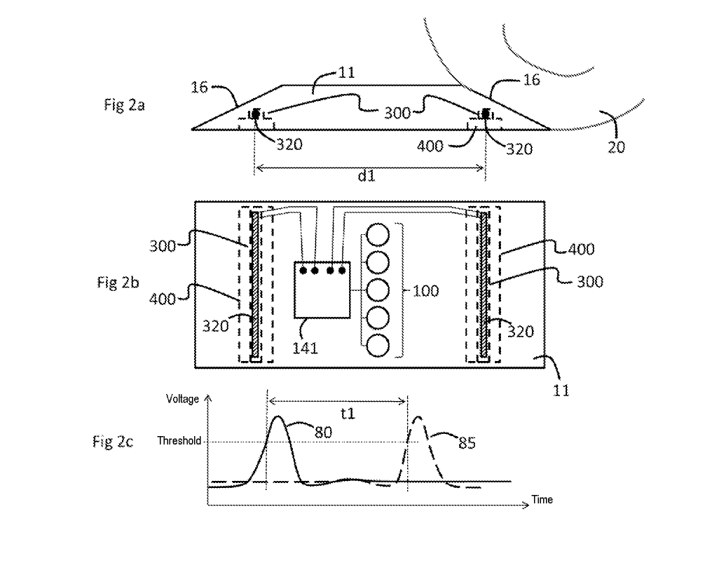

FIGS. 2a and 2b represent another exemplary embodiment in which the tire presence detection device is produced by means of two piezoelectric cables 320.

In this example of FIGS. 2a and 2b, the wear measurement system consists:
Of a casing 11, consisting of two access ramps 16 and a horizontal wear measurement zone situated between the two access ramps 16.
Of a row of wear measurement sensors 100, identical to those of FIGS. 1a and 1b, positioned along a transverse line in the direction of rolling of the vehicle arriving on the casing 11.
Of two tire presence detection devices each consisting of a piezoelectric cable 320. This piezoelectric cable 320 is positioned in a cavity 300, transversal to the direction of rolling of the vehicle arriving on the casing 11, and of height less than or equal to that of the piezoelectric cable 320. A plate 400 of rectangular form is positioned in the groove formed for this purpose, under the cavity 300. This plate 400 is fixed onto the casing 11 by any appropriate means, in order to guarantee that the piezoelectric cable 320 is held in position in its housing 300.
Of a processing electronics 141 to which the wear measurement sensors 100 and the tire presence detection sensors are connected. As in the preceding example, the processing electronics 141 also comprise an RFID reader, a time base and threshold detection electronics. Alternatively, these threshold detection electronics can be replaced by rising and/or falling edge detection electronics.

Upon the passage of a tire 20 over the casing 11 of the wear measurement system, the presence of the tire is first of all detected by a first tire presence detection device 320. Then, when the tire leaves the casing 11 of the wear measurement system, its presence is detected by a second piezoelectric tire presence detection device 320.

FIG. 2c shows, by continuous line, an example of signal 80 recorded at the output of the first piezoelectric cable 320, and by broken line, an example of signal 85 recorded at the output of the second piezoelectric cable 320.

In this exemplary embodiment, the time t1, measured by the processing electronics 141, corresponds to the time between the output signal from the first piezoelectric cable 320 crossing the threshold and the output signal from the second piezoelectric cable 320 crossing the threshold.

The speed is then calculated by applying the formula:

average speed=d1/t1

In the case of FIGS. 2a, 2b and 2c, the distance d1 is the distance separating the two piezoelectric cables 320 forming tire presence detectors.

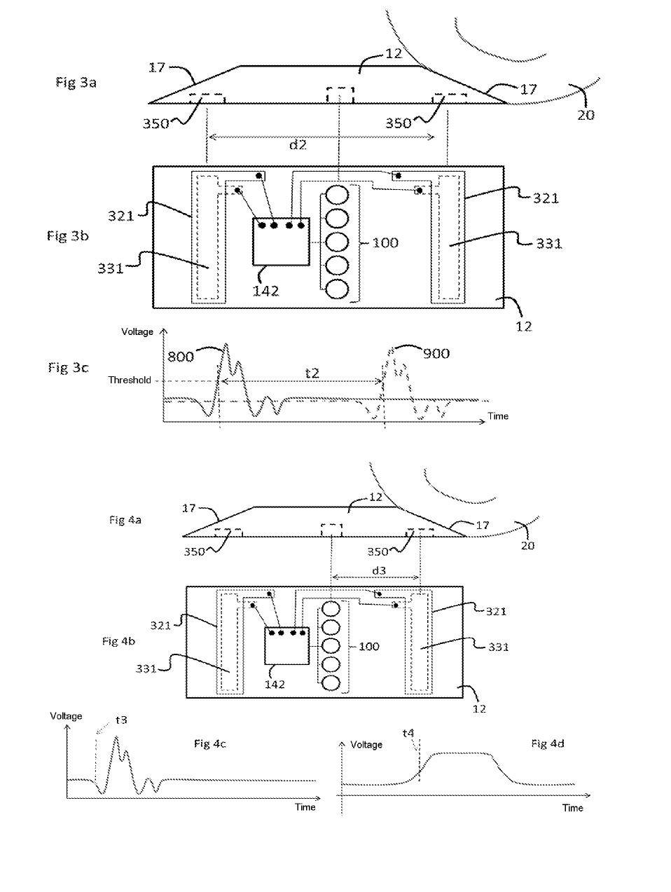

FIGS. 3a and 3b represent another exemplary embodiment in which the tire presence detection device is replaced by a piezoelectric compound, such as a paint containing piezoelectric fillers.

In this example of FIGS. 3a and 3b, the wear measurement system consists of:
A casing 12, consisting of two access ramps 17 and a horizontal wear measurement zone situated between the two access ramps 17, and a row of wear measurement sensors 100, identical to those of FIGS. 1a and 1b, positioned along a transverse line in the direction of the rolling of the vehicle arriving on the casing 12.
Two tire presence detection devices, arranged transversally to the direction of rolling of the vehicle, and consisting of a first electrode 321, a second electrode 331 and a piezoelectric paint arranged in a thin layer between the two electrodes 321 and 331. In this example, the electrodes are produced by means of silver lacquer but other principles can be employed to produce these electrodes, without that affecting the performance of the system.
Processing electronics 142 to which the wear measurement sensors 100 and the tire presence detection sensors are connected. The processing electronics 142 also contain an RFID reader, a time base and threshold detection electronics. Alternatively, these threshold detection electronics can be replaced by rising and/or falling edge detection electronics.

Upon the passage of a tire 20 over the casing 12 of the wear measurement system, the presence of the tire is first of all detected by a first tire presence detection sensor. Then, when the tire leaves the casing 12 of the wear measurement system, its presence is detected by a second piezoelectric tire presence detection sensor.

FIG. 3c shows, by continuous line, an example of signal 800 recorded at the output of the first piezoelectric sensor, and by broken line, an example of signal 900 recorded at the output of the second piezoelectric sensor.

In this exemplary embodiment, the time t2, measured by the processing electronics 142, corresponds to the time between the output signal from the first piezoelectric sensor crossing the threshold and the output signal from the second piezoelectric sensor crossing the threshold.

The speed is then is calculated by applying the formula:

average speed=d2/t2

In the case of the FIGS. 3a, 3b and 3c, the distance d2 is the distance separating the two piezoelectric sensors forming the tire presence detectors.

FIGS. 4a and 4b represent another exemplary embodiment in which the speed measurement is determined from two sensors: a tire presence detection device and a wear measurement device.

In this example, the wear measurement system consists of:
A casing 12, consisting of two access ramps 17 and a horizontal wear measurement zone situated between the two access ramps 17, and a row of wear measurements sensors 100, identical to those of FIGS. 1a and 1b, positioned along a line transversal to the direction of the rolling of the vehicle arriving on the casing 12.
The two tire presence detection devices, arranged transversally to the direction of rolling of the vehicle, and consisting of a first electrode 321, a second electrode 331 and a piezoelectric paint arranged in a thin layer between the two electrodes 321 and 331. In this example, the electrodes are produced by means of silver lacquer but other principles can be employed to produce these electrodes, without that affecting the performance of the system.
Processing electronics 142 to which the wear measurement sensors 100 and the tire presence detection sensors are connected. The processing electronics 142 also contain an RFID reader, a time base and threshold detection electronics. Alternatively, these threshold detection electronics can be replaced by a rising and/or falling edge detection electronics.

Upon the passage of a tire 20 over the casing 12 of the wear measurement system, the presence of the tire is first of all detected by a first tire presence detection sensor. Then, the wear measurement is performed when the tire is situated above the wear measurement sensors 100.

FIG. 4c shows an example of signal recorded at the output of the first piezoelectric sensor up on the passage of a tire.

FIG. 4d shows an example of signal recorded at the output of one of the sensors of the row of wear measurement sensors 100 upon the passage of a tire.

In our exemplary embodiment, the time t3 corresponds to the detection of presence of tire by the tire presence detection device, and the time t4 corresponds to the start of the measurement of the wear of the tire by a sensor of the row of wear measurement sensors 100.

These two times t3 and t4 are determined using the time base and the threshold detection function of the processing electronics 140. The time of passage t0 is then calculated simply by the relationship t0=|t4−t3|.

The speed is then calculated by applying the formula:

average speed=d3/t0.

In the case of the FIGS. 4a, 4b, 4c and 4d, the distance d3 is the distance separating the tire presence detection sensor having made it possible to detect the instant t3 and the row of wear measurement sensors 100.

FIGS. 5a, 5b, 5c and 5d represent another exemplary embodiment in which the tire presence detection device is replaced by a single piezoelectric sensor.

In the example of FIGS. 5a and 5b, the wear measurement system consists of:
A casing 13, identical to FIGS. 1a and 1b, consisting of two access ramps 18 and a horizontal wear measurement zone situated between the two access ramps 18.
A row of wear measurement sensors 100, identical to the row of wear measurement sensors 100 of FIGS. 1a and 1b, positioned along a line transversal to the direction of rolling of the vehicle arriving on the casing 13.
A tire presence detection device 520 consisting of a single piezoelectric buzzer, glued to the structure of the casing 13. That is an advantage of this configuration since a single sensor 520 makes it possible, ultimately, to measure the speed of a tire regardless of the direction of arrival of said tire on the casing 13.
Processing electronics 143 to which the wear measurement sensors 100 and the tire presence detection sensor 520 are connected. As in the preceding example, the processing electronics 143 also contain an RFID reader, a time base and threshold detection electronics. Alternatively, these threshold detection electronics can be replaced by rising and/or falling edge detection electronics.

Alternatively, the detection of an impact can be ensured, for example, by any sensor sensitive to impacts, such as accelerometers, vibration or tilt sensors, omnidirectional sensors (for example of SQ-SEN-200 type from the company SignalQuest) piezoelectric buzzers, strain gauges or sensors based on piezoelectric compounds glued at a single point of the structure of the casing.

Upon the passage of a tire 20 over the casing 13 of the wear measurement system, the tire is first of all in contact with an access ramp 18. By this, a shock wave appears in the structure of the casing 13. Said shock wave is detected by the tire presence detection sensor 520.

Secondly, the wear measurement is performed when the tire is situated above the wear measurement sensors 100.

FIG. 5c shows an example of signal recorded at the output of the piezoelectric sensor 520 upon the passage of a tire.

FIG. 5d shows an example of signal recorded at the output of a sensor of the row of wear measurements sensors 100, upon the passage of a tire over the casing 13.

In our exemplary embodiment, the time t5 corresponds to the detection of presence of the tire by the tire presence detection device 520, and the time t6 corresponds to the start of the wear measurement by a sensor of the row of wear measurement sensors 100.

These two times t5 and t6 are determined using the time base and the threshold detection function of the processing electronics 143. The time of passage t′ is then calculated simply by the relationship t′=t6−t5.

The speed is then calculated by applying the formula:

average speed=d4/t′.

In the case of FIGS. 5a, 5b, 5c and 5d, the distance d4 is the distance separating an edge in the longitudinal direction of the casing 13 and the row of wear measurement sensors 100.

In this embodiment, it may prove useful, to further refine the measurement, to take into account the speed of propagation of the shock wave in the casing. In effect, depending on the rigidity of material forming the casing, the time between the moment when the tire arrives on the casing, and the moment when the shock wave is detected by the detection sensor, can vary, and sometimes be not inconsiderable. Thus, in this case, the time t5 must be corrected downward by a parameter dependent on the propagation properties of the material forming the casing.

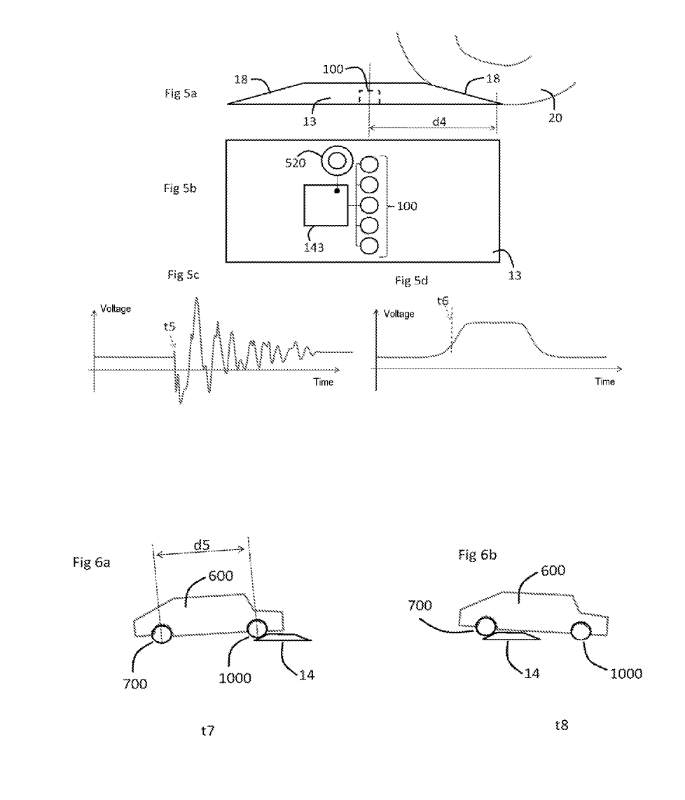

FIGS. 6a and 6b show an alternative to the preceding solutions in order to measure the speed of the vehicle passing over the tire wear measurement system 14.

In this example, the wear measurement system 14 is provided, for example, with at least any one of the tire presence detection devices given in the examples of FIG. 1, 2, 3, 4 or 5.

The wear measurement system 14 is also provided with a row of tire wear measurement sensors, processing electronics incorporating a time base and threshold detection electronics. Alternatively, these threshold detection electronics can be replaced by rising and/or falling edge detection electronics.

Finally, the wear measurement system 14 is also provided with an RFID reader.

Furthermore, the wear measurement system 14 is connected to a remote database, containing the value of the distance d5 separating the two axles 700 and 1000 of the vehicle 600. This database contains the value of the distances d5 separating the axles of all kinds of vehicles which renders the system operative for all kinds of vehicles.

FIG. 6a shows the arrival of a vehicle 600 on the wear measurement system 14 at the time t7. The arrival of said vehicle is detected at the moment of the passage of the first axle 1000 over the tire presence detection device incorporated in the wear measurement system 14.

At this instant, the value t7 of the time base incorporated in the wear measurement system is stored in a memory of the processing electronics of said wear measurement system.

FIG. 6b shows the passage of the second axle 700 of the vehicle 600 over the wear measurement system 14 at the time t8.

As for the first axle, when the tire presence detection device is activated, the value t8 of the time base incorporated in the wear measurement system is stored in a memory of the processing electronics of said wear measurement system.

The time of passage of the vehicle is then calculated simply by means of the following formula:

t″=t8−t7

Upon the passage of a vehicle 600 over the wear measurement system 14, the RFID reader incorporated in the wear measurement system is activated in order to record the identification number of an RFID which has been previously affixed to the vehicle 600.

In this way, the vehicle 600 is identified and the wear measurement system 14 can access the value of the distance d5 contained in the remote database.

The speed of passage of the vehicle can then be calculated by means of the following formula:

average speed=d5/t″

Alternatively, the time of passage of the vehicle, and its identification, are transmitted to the remote database and the calculation is performed directly in the database.

In an alternative embodiment, it is also possible to detect the second axle by means of the measurement device of said system. In this case, the detection is made on the basis of the output signal from the measurement sensors, as described in FIGS. 4d and 5d and the distance d5 recovered in the remote database must be increased by the value d6 which is the distance separating the tire presence detection device from the wear measurement device. This distance d6 is not represented in the figures.

The speed of passage of the vehicle can then be calculated by means of the following formula:

average speed=(d5+d6)/t″

1-12. (canceled)

13: A speed assessment system for assessing a speed of a vehicle, the speed assessment system comprising:
a tire measurement system, which assesses a state of a tire of the vehicle, the tire measurement system including a casing placed on a ground surface;
a timing device, which determines at least two instants of passage of the vehicle over two distinct or non-distinct points of passage of the casing of the tire measurement system; and
a processor, which calculates a speed of passage of the vehicle over the casing based on the instants of passage and on at least one of: dimensional data of the casing and dimensional data of the vehicle.

14. The speed assessment system according to claim 13, wherein the tire measurement system is a wear measurement system.

15. The speed assessment system according to claim 13, further comprising a memory, which stores the dimensional data of the casing.

16. The speed assessment system according to claim 13, further comprising a reader, which reads vehicle identification information.

17. The speed assessment system according to claim 13, further a communication device, which exchanges information with a remote database, the exchanged information including the dimensional data of the vehicle.

18. The speed assessment system according to claim 14, wherein the wear measurement system includes an eddy-current sensor or a variable-reluctance sensor.

19: A method for assessing a speed of a vehicle passing over a casing of a tire measurement system for assessing a state of a tire of the vehicle, the method comprising steps of:
determining a first instant of passage of the vehicle over the casing;
determining a second instant of passage of the vehicle over the casing;
calculating a speed of passage of the vehicle over the casing based on the first and second instants of passage and at least one of: dimensional data of the casing and dimensional data of the vehicle.

20. The method according to claim 19, wherein the steps of determining the first instant of passage and determining the second instant of passage include detecting a passage of a same wheel at two different points of the casing.

21. The method according to claim 19, wherein the steps of determining the first instant of passage and determining the second instant of passage include detecting a passage of two distinct axles of the vehicle at a single point of the casing.

22. The method according to claim 19, wherein the steps of determining the first instant of passage and determining the second instant of passage include detecting a passage of two distinct axles of the vehicle at two distinct points of the casing.

23. The method according to claim 19, wherein the steps of determining the first instant of passage and determining the second instant of passage include detecting an impact on the casing and detecting a passage of a wheel at a point of the casing.

24. The method according to claim 19, further comprising a step of correcting a determination of the first instant of passage based on a rigidity of a material forming the casing.
